(19) United States
(12) Patent Application Publication
(10) Pub. No.: US 2012/0089918 A1
(43) Pub. Date: Apr. 12, 2012

(54) METHOD FOR MANAGING APPLICATIONS OF PORTABLE DEVICE

(75) Inventors: Gary Kung, Santa Ana, CA (US); Johnny Chen, Santa Ana, CA (US)

(73) Assignee: I O INTERCONNECT, LTD., Santa Ana, CA (US)

(21) Appl. No.: 13/204,652

(22) Filed: Aug. 6, 2011

Related U.S. Application Data
(60) Provisional application No. 61/392,445, filed on Oct. 12, 2010.

(51) Int. Cl. G06F 15/177

(52) U.S. Cl. 715/736

(57) ABSTRACT

A method for managing applications of a portable device by a computer electrically connected to the portable device is provided, wherein the computer connects to the internet. Application information from websites is obtained by the computer after recognizing the portable device, wherein the application information includes recommendation lists of the websites. An application is downloaded from the websites to the portable device via the Internet connection of the computer and not the Internet connection of the portable device. The downloaded application is provided to the devices other than the portable device by the computer via the internet.

### CROSS REFERENCE TO RELATED APPLICATIONS

This application claims the benefit of U.S. Provisional Application No. 61/392,445, filed on Oct. 12, 2010, the entirety of which is incorporated by reference herein.

### BACKGROUND OF THE INVENTION

1. Field of the Invention

The present invention is related to a method for managing applications of portable device, and more particularly to a method for managing applications of portable devices by a computer.

2. Description of the Related Art

Along with the advancement of electronic technology, various portable devices, that are able to provide many different applications (apps), have been developed and brought into the market in order to meet consumers' requirements, wherein the applications that run on the portable devices (such as mobile phones, personal digital assistants (PDAs) and other hand-held devices) are referred to as mobile applications.

In general, mobile applications are either pre-installed on the portable devices during the manufacturing thereof, or downloaded/installed by users from application stores or mobile software distribution platforms. However, a portable device must connect to the internet to link to the websites of the application stores or the mobile software distribution platforms, so as to download/install the applications from the websites to the portable device, thus increasing data transmission charges for the portable device.

Therefore, a method for downloading new applications without data transmission charge is desired.

### BRIEF SUMMARY OF THE INVENTION

An embodiment of a method for managing applications of a portable device is provided. A portable device is electrically connected to a computer, wherein the computer connects to the internet. The type of the portable device is recognized by the computer. Application information is displayed on a screen of the computer according to the type of the portable device, wherein the application information is obtained from a website through the internet.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a schematic diagram illustrating communication between a computer and a portable device according to an embodiment of the invention, wherein the computer connects to the internet;

FIG. 2 shows a method for managing applications (apps) of a portable device according to an embodiment of the invention;

FIG. 3 shows an example illustrating a window displayed on a screen of the computer in FIG. 1;

FIG. 4 shows an example illustrating a window displayed on a screen of the computer in FIG. 1;

FIG. 5 shows a schematic diagram illustrating the computer and a mass storage device according to an embodiment of the invention; and

FIG. 6 shows an example illustrating a window displayed on the screen of the computer connected to the mass storage device according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

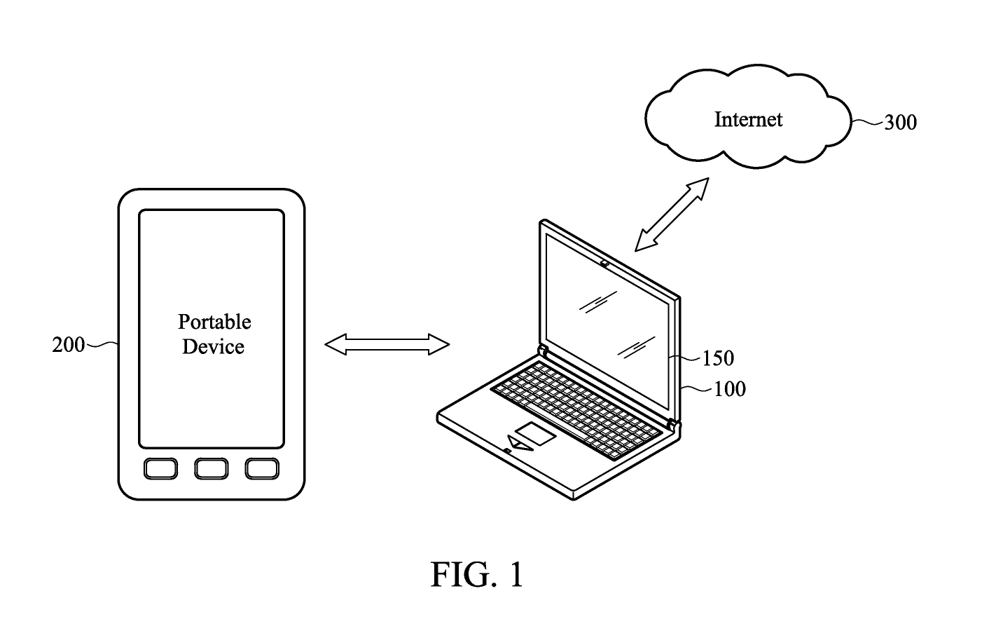

FIG. 1 shows a schematic diagram illustrating communication between a computer 100 and a portable device 200 according to an embodiment of the invention, wherein the computer 100 connects to the internet 300. The portable device 200 may be a hand-held phone or a tablet computer, which has a specific operating system (OS), such as an Android OS, iOS, or webOS and so on. The portable device 200 is electrically connected to the computer 100 by a wired manner (e.g. USB) or a wireless manner (e.g. BT or WiFi).

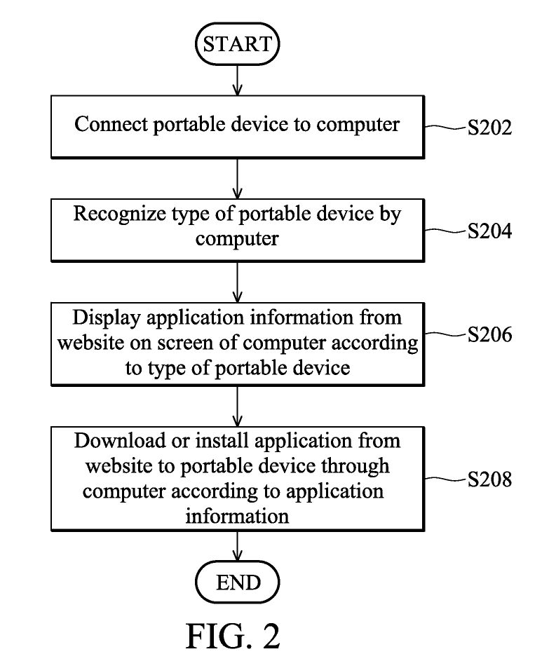

FIG. 2 shows a method for managing applications (apps) of a portable device according to an embodiment of the invention. Referring to FIG. 1 and FIG. 2 together, first, in step S202, the portable device 200 is electrically connected to the computer 100, wherein the computer 100 connects to the Internet 300. Next, in step S204, the computer 100 may recognize the type of the portable device 200 according to identification information provided by the portable device 200, so as to recognize the OS of the portable device 200 according to the type of the portable device 200. In one embodiment, the identification information of the portable device 200 comprises a Vendor ID (VID) and a Product ID (PID). If the computer 100 does not recognize the identification information of the portable device 200, the computer 100 may automatically link to specific websites via the Internet 300 according to the identification information of the portable device 200, so as to gather information corresponding to the portable device 200 for accomplishing the recognition procedure. For example, the computer 100 may link to a website which provides various device drivers and then the computer 100 may download a device driver corresponding to the identification information of the portable device 200, thus accomplishing recognition of the portable device 200.

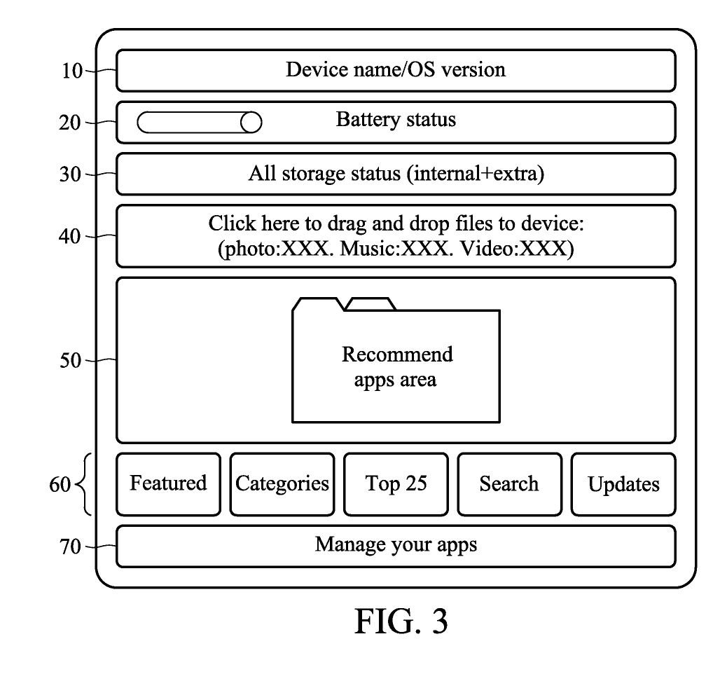

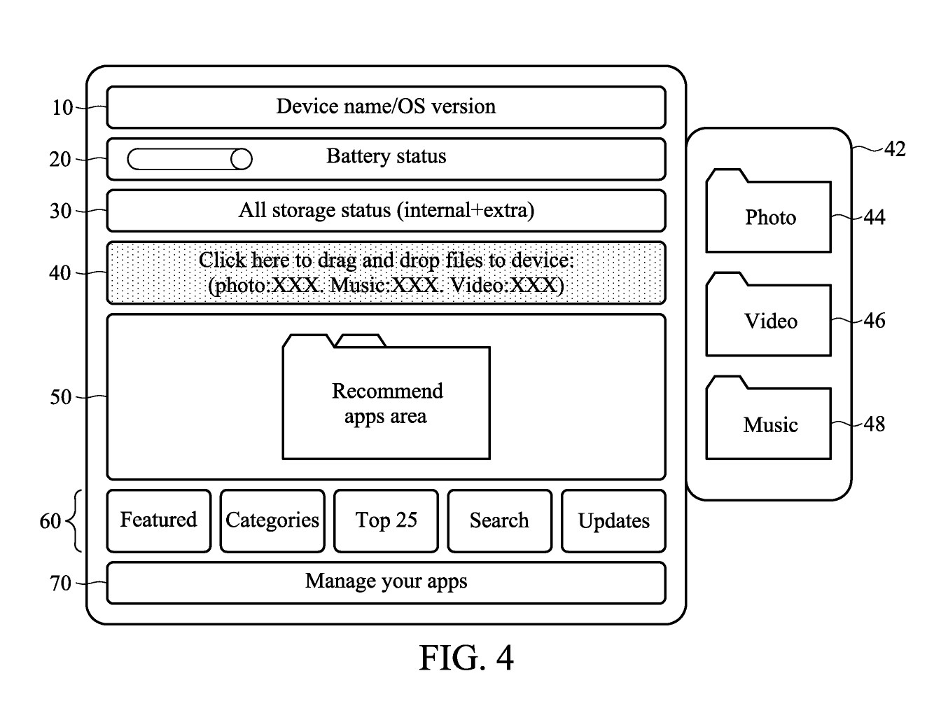

When the portable device 200 is recognized, the computer 100 may show the information regarding the portable device 200 on a screen 150 of the computer 100 in FIG. 1. For example, FIG. 3 shows an example illustrating a window displayed on a screen 150 of the computer 100 in FIG. 1. Referring to FIGS. 1-3 together, after the portable device 200 is recognized, the computer 100 displays the information and the status of the portable device 200 on the screen 150, such as device name/OS version (e.g. button 10 of FIG. 3), battery status (e.g. button 20 of FIG. 3), storage capacity (e.g. button 30 of FIG. 3) and so on. Simultaneously, the computer 100 may link to the websites which provide various applications via the Internet 300, so as to retrieve information corresponding to the applications that are compatible with the portable device 200 according to the OS of the portable device 200. Next, in step S206, the computer 100 may display the application information, as with button 50 of FIG. 2, for user reference. In one embodiment, the application information is obtained according to recommendation lists of the websites, wherein the recommendation lists comprise what is most popular or most recommended for the portable device 200 at that time, for example, “top 25 applications”, “free”, “paid”, “what's new” and “advertising” etc. If the “drag and drop” function is clicked, as shown in button 40 of FIG. 4, the computer 100 may automatically open a sub-window 42 which exhibits the folders 44, 46 and 48 of the portable device 200 on the screen 150, and then any application shown in the recommend application area (e.g. 50 of FIG. 4) may be chosen to download or install to the designate folder of the portable device 200 via the computer 100 (step S208). Thus, a new application is downloaded or installed from the website to the portable device 200 via the internet 300 and the computer 100. It is to be noted that the portable device 200 does not directly access the internet and load the website; thereby no data transmission charge is charged to the portable device 200. Furthermore, in general, a screen of a computer has a larger size than a portable device, thus it is more comfortable for a user to manage the applications of the portable device through the computer.

In one embodiment, before downloading or installing a new application from the internet 300 to the portable device 200 via the computer 100, a trial application corresponding to the new application may be downloaded and installed in the computer 100, and then the user may perform the trial application in the computer 100, so as to determine whether to download or install the new application to the portable device 200.

In order to simplify the display setting and display the recommend applications in the area 50 of FIG. 4 quickly, the computer 100 further provides various function buttons (e.g. 60 of FIG. 4) according to a predefined setting, to show the applications corresponding to the function buttons. For example, the user may set the function buttons according to characters of the applications, such as “feature”, “category”, “billboard” or “new arrivals”. Moreover, the computer 100 further provides a button, such as button 70, for the user to manage the applications of the portable device 200 via the computer 100.

When the applications are downloaded to the computer 100 for storage or installation to the portable device 200, the computer 100 may share the downloaded applications or the application information thereof to other devices via the internet 300 with Email, Short message services (SMS), and social network means and so on.

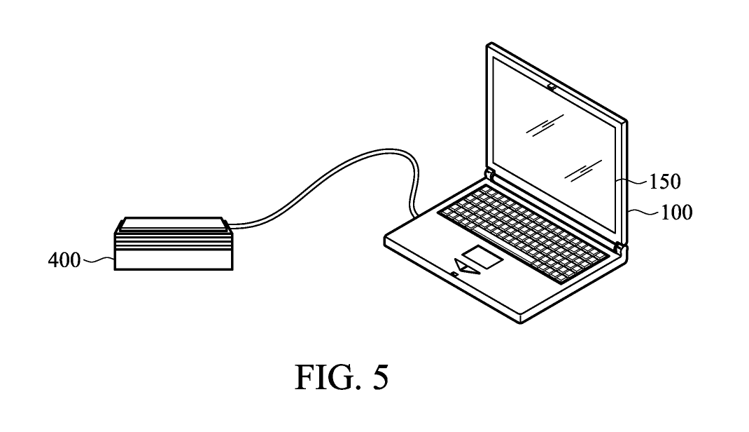

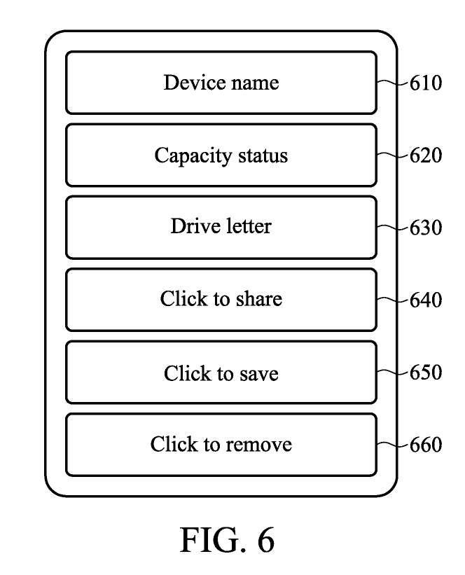

According to an embodiment of the invention, the applications that are downloaded or installed from websites to the portable device may be backed up/stored to mass storage devices via the computer 100. Referring to FIG. 5, it shows a schematic diagram illustrating the computer 100 and a mass storage device 400 according to an embodiment of the invention. Similarly, when the mass storage device 400 is electrically connected to the computer 100, the computer 100 will recognize the kind/type of the mass storage device 400, such as a hard disc (HD) or a flash memory, and then the computer 100 will display the information and the status of the mass storage device 400 (e.g. device name 610 and capacity status 620 of FIG. 6) on the screen 150 of the computer 100, as shown in FIG. 6. FIG. 6 shows an example illustrating a window displayed on the screen 150 of the computer 100 connected to the mass storage device 400 according to an embodiment of the invention. After the mass storage device 400 is recognized, the applications may be transferred between the mass storage device 400 and the computer 100 by using the predefined button functions. For example, “Drive letter” button 630 is used to open a sub-window to display the folders of the mass storage device 400; “Click to share” button 640 is used to upload the designated applications from the folders of the mass storage device 400 to the computer 100; “Click to save” button 650 is used to download the designated applications from the computer 100 to the folders of the mass storage device 400; and “Click to remove” button 660 is used to delete the designate applications from the folders of the mass storage device 400.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for managing applications of portable device, comprising:
electrically connecting a portable device to a computer, wherein the computer connects to the internet;
recognizing a type of the portable device by the computer; and
displaying application information on a screen of the computer according to the type of the portable device, wherein the application information is obtained from a website through the internet.

2. The method as claimed in claim 1, further comprising:
downloading or installing an application from the website to the portable device through the computer and the internet according to the application information.

3. The method as claimed in claim 2, further comprising:
providing the application or the application information from the computer to the devices other than the portable device through the internet.

4. The method as claimed in claim 2, further comprising:
electrically connecting a mass storage device to the computer;
displaying information and the status of the mass storage device on the screen of the computer according to the type of the mass storage device; and
transferring the application between the computer and the mass storage device.

5. The method as claimed in claim 2, wherein the step of downloading or installing the application from the website to the portable device through the computer further comprises:
downloading or installing a trial application corresponding to the application from the website to the computer through the internet; and
performing the trial application, so as to determine whether to download or install the application to the portable device.

6. The method as claimed in claim 1, further comprising:
displaying information and the status of the portable device on the screen of the computer according to the type of the portable device.

7. The method as claimed in claim 1, wherein the step of recognizing the type of the portable device by the computer further comprises:
obtaining identification information provided by the portable device;
obtaining the type of the portable device when the identification information is recognized; and
recognizing the operating system of the portable device according to the type of the portable device.

8. The method as claimed in claim 7, wherein the step of recognizing the type of the portable device by the computer further comprises:
linking to a website through the internet according to the identification information when the identification information has not been recognized, so as to gather information corresponding to the portable device for accomplishing the recognition procedure.

9. The method as claimed in claim 7, wherein the step of displaying the application information further comprises:
linking to the website by the computer through the internet; and
retrieving the application information by the computer according to the operating system of the portable device.

10. The method as claimed in claim 1, wherein the step of displaying the application information further comprises:
displaying the application information with specific characters on the screen of the computer, wherein the specific characters are designated according to a predefined setting of the computer.

11. The method as claimed in claim 1, wherein the application information is obtained according to recommendation lists of the website.
